(19) United States
(12) Patent Application Publication
(10) Pub. No.: US 2004/0023628 A1
(43) Pub. Date: Feb. 5, 2004

(54) Ultra-selective broadband bandpass filter using hybrid technology

(76) Inventors: Dominique Lo Hine Tong, Rennes (FR); Jean-Yves Le Naour, Pace (FR); Olivier Riou, Treffiagat (FR)

Correspondence Address: JOSEPH S. TRIPOLI, THOMSON LICENSING INC., 2 INDEPENDENCE WAY, P.O. BOX 5312, PRINCETON, NJ, 08543-5312, US

(21) Appl. No.: 10/417,905

(22) Filed: Apr. 17, 2003

(30) Foreign Application Priority Data
Apr. 23, 2002 (FR) 02/05339

(51) Int. Cl. H04B 1/00

(52) U.S. Cl. 455/130; 455/150.1

(57) ABSTRACT

The present invention relates to an ultra-selective broadband bandpass filter using hybrid technology. The invention is more particularly applicable to broadband wireless communication systems. According to the invention, means for rejecting the frequencies outside the bandwidth of the filter are made using hybrid technology employing conventional microstrip lines, discrete components and microstrip lines called suspended microstrip lines.

### FIELD OF THE INVENTION

The present invention relates to an ultra-selective broadband bandpass filter using hybrid technology. The invention is more particularly applicable to broadband wireless communication systems.

### BACKGROUND OF THE INVENTION

The rapid and continuous expansion of broadband wireless communication systems in the market leads to a constant increase in the overall size of the frequency spectrum. As a result, each receiving system is forced to strongly reject the interference signals transmitted in the frequency bands close to the receiving band of the system so as to preserve the sensitivity of the receiver. Filtering is therefore an essential function in any novel wireless communication system.

In the system receiving sequence, filtering generally takes place after a frequency transposition, for example into the L band (a band between 1 and 2 GHz), of the signal present at the input of the receiving sequence.

The filtering operation must generally comply with many restrictions, in particular:

a bandwidth which is relatively wide with respect to the central frequency (>50%),

a very high selectivity,

a very small variation in the group propagation time, hereinafter denoted GPT, in particular at the band limit,

good compactness, and

a cost compatible with that of mass production.

The type of frequency response for the filter and the technology employed to manufacture it must be carefully chosen so that the filter satisfies the aforementioned restrictions.

Possible Frequency Response Types

The most commonly used responses are of the Butterworth, Bessel or Chebyshev type. They are generally dedicated to producing filters whose requirements in terms of selectivity and of GPT are not highly stringent. To obtain a high selectivity, it is necessary to increase the order of the filter. However, in this case, the filter loses compactness and the GPT is highly degraded at the band limit.

High selectivity may also be obtained by a response of the Cauer type (also called elliptical type). The Cauer response is characterized by minimum fading uniformly distributed outside the band, and by the presence of transmission zeros placed symmetrically on each side of the bandwidth at given frequencies for which the attenuation is theoretically infinite. These zeros give good rejection at the band limit of the filter, but, however, their number and their location depend solely on the order of the filter and on the attenuation required. This lack of freedom is undesirable for highly selective filters for which it is then necessary to increase the order, thereby leading to degradation of the GPT. Another drawback of the Cauer response arises from the large range of values of the elements (inductors, capacitors) used which, in many cases, in particular in the microwave region, are difficult to produce.

The last type of response relates to responses of the quasi-elliptical type. In this case, the number of transmission zeros and their locations at zero frequency (DC), at finite frequencies and at infinite frequencies are fixed according to the template of the filter to be produced. Thus, by optimum choice of these parameters and with a minimum order, a response of quasi-elliptical type is suitable for producing special filters such as filters with high selectivity, with low variation of GPT (i.e. with linear phase), with an assymmetrical response, etc. One of the main limitations of this type of filter lies in the fact that it is sometimes very difficult to obtain a circuit diagram which can be produced and which is compatible with the existing manufacturing technologies.

Possible Manufacturing Technologies

The manufacturing technologies presented below are the main technologies employed for producing L band filters.

Technology using discrete components offers the advantage of compactness and low manufacturing cost. This technology is more particularly dedicated to low-frequency applications (<300 MHz) and for low-selectivity filters, because of the low quality factor of the discrete elements and of their manufacturing tolerance which still remains too high for high frequencies.

“Microstrip line” technology is commonly used in the microwave region. Depending on the permittivity of the substrate used, the technology makes it possible to produce filters of varying compactness. This compactness may be increased by the integration of discrete components in addition to the microstrip lines when the said components do not play a critical role. However, for very selective filters, its use remains very limited because of the quality factor of its elements which is too low beyond 1 GHz, except if the dielectric substrate is of very good quality, which represents an additional cost.

To gain in terms of quality factor, one solution consists in using “suspended microstrip line” technology, in which the lines are in a medium close to air between two earth planes.

However, compared with the microstrip line technology, this gain in quality is made to the detriment of the overall filter size (since the permittivity of the medium is then very much less than that of the substrate of the microstrip line technology).

### SUMMARY OF THE INVENTION

The aim of the invention is to produce a bandpass filter having a relatively wide bandwidth compared with the central frequency of the filter and a very low variation in the group propagation time, very good frequency selectivity, good compactness and a cost compatible with mass production.

To this end, according to the invention, it is proposed to produce a filter having a response of the quasi-elliptical type using hybrid manufacturing technology combining microstrip lines with discrete elements and suspended microstrip lines.

Also, the subject of the invention is a bandpass filter comprising means for rejecting frequencies outside the bandwidth of the said filter which means are made from microstrip line technology, characterized in that at least one of the means for rejecting the frequencies at the upper limit of the bandwidth is made by at least one resonant circuit, the microstrip lines of which are suspended, the said at least one resonant circuit being tuned to at least one frequency to be rejected.

Moreover, means for rejecting the frequencies outside the bandwidth other than the means for rejecting the frequencies at the upper band limit (for example the means for rejecting infinite frequencies or frequencies at the lower band limit) are preferably made partially with discrete components in order to increase the compactness of the filter. Likewise, the frequency response of the filter is preferably of the quasi-elliptical type.

The subject of the invention is also a chain for transmitting and/or receiving high-frequency signals, characterized in that it comprises a bandpass filter as described above.

### BRIEF DECRIPTION OF THE DRAWINGS

Other characteristics and advantages of the invention will become apparent on reading the following detailed description which is made with reference to the appended drawings, among which:

FIG. 1 shows the circuit diagram of a bandpass filter according to the invention;

FIG. 2 shows the frequency response of the filter of FIG. 1;

FIGS. 3A and 3B illustrate the manufacturing technologies employed for producing the bandpass filter of the invention;

FIG. 4 is a frequency response curve illustrating the performance, in terms of rejection, of the hybrid technology compared to the simple microstrip technology; and

FIG. 5 is a curve illustrating the performance, in terms of GPT, of the hybrid technology compared to the simple microstrip technology.

### DESCRIPTION OF PREFERRED EMBODIMENTS

According to the invention, a bandpass filter made from hybrid technology taking maximum benefit from the advantages of each of the filter manufacturing technologies presented above is provided, that is:

compactness of the technology with discrete components;

high quality factor of the microstrip line technology up to frequencies less than about 1 GHz; and

high quality factor of the suspended microstrip technology for frequencies greater than 1 GHz.

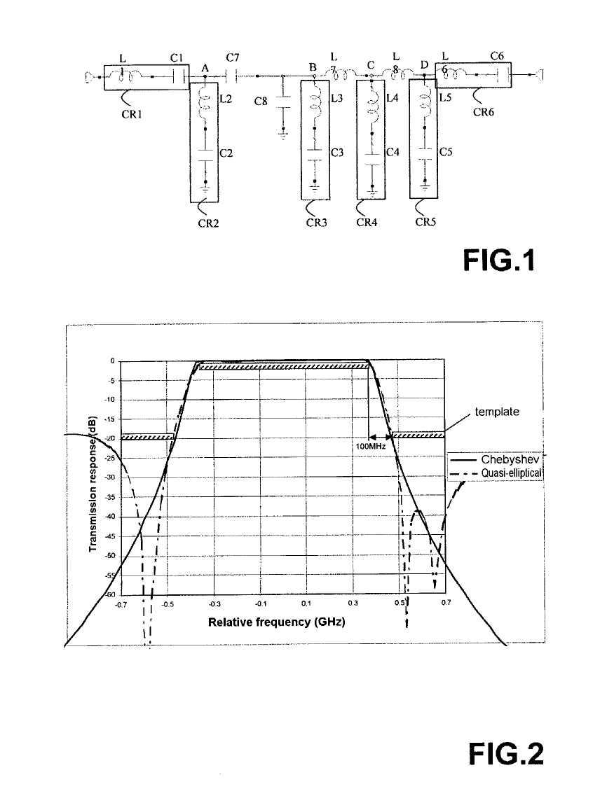

FIGS. 1 to 5 illustrate one embodiment of a bandpass filter according to the invention. The response of this filter is of the quasi-elliptical type and its order is as small as possible in order to comply with both the criteria of compactness and of rejection outside the bandwidth. An optimum number of transmission zeros is placed on each side of the bandwidth of the filter in order to comply with both the criteria of selectivity and of GPT.

The circuit diagram of this filter is shown in FIG. 1. The figure shown is of order 4. It comprises a plurality of resonant circuits and of localized inductive or capacitive elements. If the diagram of FIG. 1 is described in a more detailed manner, the bandpass filter comprises six resonant circuits, referenced CR1 to CR6, two isolated capacitive elements C7 and C8 and two isolated inductive elements L7 and L8. Each resonant circuit CRi is formed from an inductive element Li and a capacative element Ci connected in series, where iε[1 . . . 6].

The resonant circuit CR1 is mounted in series with the capacitive element C7, the inductive elements L7 and L8, and the resonant circuit CR6 between the input terminal and the output terminal of the filter. Both resonant circuits CR1 and CR6 have a resonant frequency in the bandwidth. The resonant circuits CR2, CR3, CR4 and CR5 are connected between nodes of the filter, respectively referenced A, B, C and D, and earth. Finally, the capacitive element C8 is placed between the node B and earth.

In the example of FIG. 1, the node A is located between the elements C1 and C7, the node B between the elements C7 and L7, the node C between the elements L7 and L8 and the node D between the elements L8 and L6.

This filter comprises the following transmission zeros:

one transmission zero at zero frequency (DC) generated by the element C7;

three transmission zeros at the infinite frequencies generated by the elements L7, L8 and C8;

two transmission zeros at frequencies close to the lower cut-off frequency generated by the resonant circuits CR2 and CR3; and

two transmission zeros at frequencies close to the upper cut-off frequency generated by the resonant circuits CR4 and CR5.

With this circuit diagram, if a bandpass filter having a central frequency close to 1.5 GHz and a relative bandwidth of about 50% is produced, the values of the components are between 1 and 10 nH for the inductors and between 2 and 5 pF for the capacitors. These values are perfectly attainable in the hybrid technology chosen.

The frequency response of this filter is shown in FIG. 2. The minimum rejection at 100 MHz of the upper and lower cut-off frequencies is 20 dB, which meets the selectivity requirements of the filter at the bandwidth limit. This figure also shows, by way of comparison, that in order to obtain the same selectivity with a response of the Chebyshev type, a much higher order (>7) would be necessary, with the aforementioned drawbacks, that is a large overall size and high degradation of the GPT at the band limit. The two transmission zeros generated by the resonant circuits CR4 and CR5 and one of the transmission zeros generated by the resonant circuits CR2 and CR3 appear very clearly in this figure.

According to the invention, the inductors L1, L2, L3, L6, L7 and L8 are made in the form of inductive microstrip lines. This makes it possible to benefit from a high quality factor and a tighter tolerance on their values. The capacitors C1, C2, C3, C6, C7 and C8 are made using discrete components for the sake of compactness. These components have a quality factor which is sufficient to produce the two transmission zeros at frequencies close to the lower cut-off frequency of the filter. Finally the resonant circuits CR4 and CR5, producing transmission zeros at frequencies close to the upper cut-off frequency of the filter, are made by quarter-wave lines in open circuit with suspended microstrip lines.

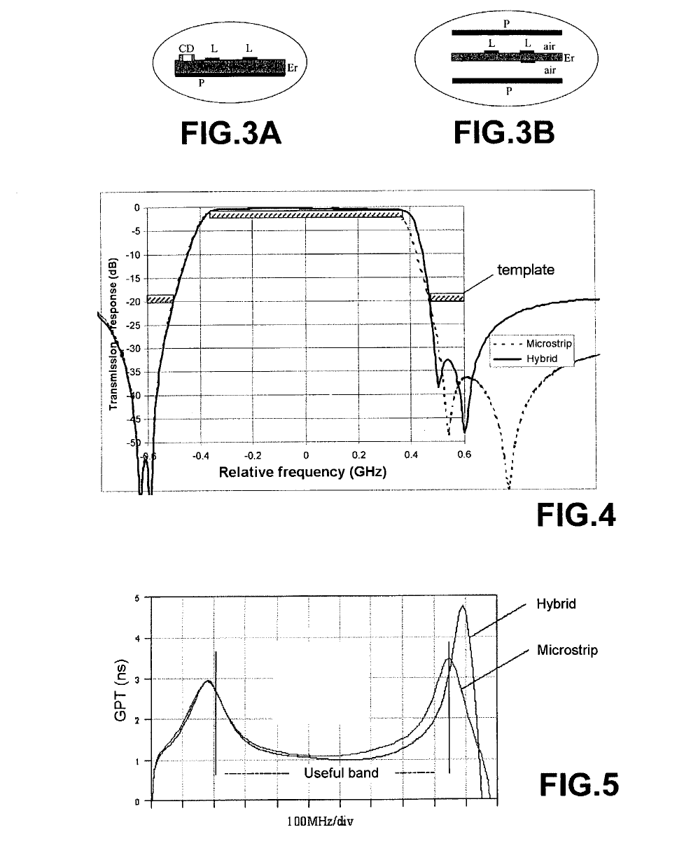

By way of information, the microstrip line technology with discrete components and the suspended microstrip line technology are respectively illustrated by FIGS. 3A and 3B. Each of these figures shows one or more microstrip lines L made on a dielectric substrate S of permitivity Er with an earth plane P. In microstrip line technology with discrete components, the earth plane P is made on the face of the substrate S which bears neither a line L nor a discrete component CD. In suspended microstrip line technology, the earth plane P is separated from the substrate by an air layer. Optionally, it is possible to have two plates, one located on each side of the substrate S, each plate being separated from the substrate S by a layer of air.

As can be seen in FIG. 4, the use of microstrip line technology does not allow the desired bandwidth and high frequency rejection to be obtained simultaneously. It is for this reason that the resonant circuits CR4 and CR5 are produced in the suspended microstrip line technology. Furthermore, the microstrip line technology allows simple and effective adjustment of the transmission zeros by means of screws (they modify the electromagnetic field lines present between the microstrip lines and the earth plane).

Moreover, as shown in FIG. 5, this hybrid technology also makes it possible to reduce variations in GPT in the useful band and therefore minimizes signal distortions.

Preferably, the resonant circuits CR4 and CR5, made with suspended microstrip lines, are physically placed side by side in the circuit in order to respond even better to the requirement of compactness.

It is also important to note that the technologies implemented here remain compatible with the high-frequency functions upstream (use of the same substrate) in the receiver, which has a major effect on the cost of the whole of the receiving function. The technique proposed may of course also be implemented in the transmission chain of the system, for example, in order to filter an interference signal generated in a frequency band close to the useful band.

What is claimed is:

1) Bandpass filter comprising means for rejecting frequencies outside the bandwidth of the said filter which means are made from microstrip line technology, characterized in that at least one of the means for rejecting the frequencies at the upper limit of the bandwidth is made by at least one resonant circuit (CR4;CR5), the microstrip lines of which are suspended, the said at least one resonant circuit being tuned to at least one frequency to be rejected.

2) Bandpass filter according to claim 1, characterized in that the said means for rejecting the frequencies outside the bandwidth other than the means for rejecting the frequencies at the upper limit of the band are in addition partially made with discrete components.

3) Bandpass filter according to claim 2, characterized in that the said means for rejecting the frequencies outside the bandwidth other than the means for rejecting the frequencies at the upper band limit comprise inductive elements and capacitive elements, and in that the inductive elements are made by inductive microstrip lines and the capacitive elements by discrete components.

4) Bandpass filter according to claim 1, characterized in that the means for rejecting the frequencies at the upper limit of the band are physically brought together side by side in order to increase the compactness of the filter.

5) Bandpass filter according to claim 1, characterized in that the frequency response of the filter is of the quasi-elliptical type.

6) Chain for transmitting and/or receiving high-frequency signals, characterized in that it comprises a bandpass filter comprising means for rejecting frequencies outside the bandwidth of the said filter which means are made from microstrip line technology, at least one of the means for rejecting the frequencies at the upper limit of the bandwidth being made by at least one resonant circuit (CR4;CR5), the microstrip lines of which are suspended, the said at least one resonant circuit being tuned to at least one frequency to be rejected.
